(19) United States
(12) Patent Application Publication
(10) Pub. No.: US 2026/0059601 A1
(43) Pub. Date: Feb. 26, 2026

(54) Terminal, System, and Method for Mapping Resources in Sidelink Communication Procedures

(71) Applicant: Apple Inc., Cupertino, CA (US)

(72) Inventors: Chunxuan Ye, San Diego, CA (US); Wei Zeng, Saratoga, CA (US); Seyed Ali Akbar Fakoorian, San Diego, CA (US); Haitong Sun, Saratoga, CA (US); Dawei Zhang, Saratoga, CA (US); Chunhai Yao, Beijing (CN); Huaning Niu, San Jose, CA (US); Oghenekome Oteri, San Diego, CA (US); Weidong Yang, San Diego, CA (US); Hong He, San Jose, CA (US)

(21) Appl. No.: 19/102,844

(22) PCT Filed: Aug. 12, 2022
(86) PCT No.: PCT/CN2022/112028

§ 371 Date: Feb. 10, 2025

(51) Int. Cl. H04W 76/19; H04W 72/25

(52) U.S. Cl. CPC H04W 76/19; H04W 72/25

(57) ABSTRACT

A terminal may include a processor configured to obtain a sidelink (SL) monitoring information indicating resources selected for a bandwidth that includes a portion of an unlicensed spectrum. The processor may be configured to perform a resource selection procedure in accordance with the SL monitoring information. The terminal may include a transmitter coupled to the processor and configured to transmit the SL transmission, in which resources are selected in accordance with the source selection procedure.

### FIELD

The present application relates to wireless devices and wireless networks, including devices, circuits, and methods for performing Sidelink communication procedures.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

### SUMMARY

In one or more embodiments, a terminal includes a processor configured to obtain configuration parameters indicating resources selected from a portion of an unlicensed spectrum. The processor is configured to perform a resource selection procedure in accordance with the configuration parameters. The terminal includes a transmitter coupled to the processor and configured to transmit the SL transmission, in which resources are selected in accordance with the resource selection procedure.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates an example block diagram of a UE, according to some aspects.

FIG. 3 illustrates an example block diagram of a BS, according to some aspects.

FIG. 4 illustrates an example block diagram of wireless communication circuitry, according to some aspects.

FIGS. 5A and 5B are diagrams illustrating examples of Sidelink (“SL”) communication procedures, according to some aspects.

FIGS. 6A and 6B are a flowcharts detailing methods of selecting resources in an SL communication procedure, according to some aspects.

FIG. 7 is a diagram illustrating an example of a SL communication procedure, according to some aspects.

FIG. 8 is a flowchart detailing a method of selecting resources in an SL communication procedure, according to some aspects.

FIG. 9 is a diagram illustrating an example of an SL communication procedure, according to some aspects.

FIG. 10 is a diagram illustrating a process for reporting an SL transmission status, according to some aspects.

FIG. 11 is a flowchart detailing a method of mapping time resources in an SL communication procedure, according to some aspects.

FIG. 12 is a flowchart detailing a method of identifying time resources mapped for an SL transmission, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study and evaluate enabling Sidelink (SL) communication procedures, signaling, and resource selection on portions of an unlicensed spectrum in 5G/New Radio (NR) environments. Thus, disclosed herein are various solutions for performing and improving SL transmissions on portions of the unlicensed spectrum, including: 1) resource selections in PSFCH Cross-COT transmissions; 2) resource selections for PSFCH transmissions to maintain a COT; 3) resource selections for PSFCH retransmissions; 4) resource selections for SL HARQ reporting; and 5) resource selections for PSFCH retransmissions in listen-before-talk (“LBT”) applications.

In accordance with one or more embodiments, a user equipment (UE) device or terminal communicating with other terminals (other wireless communication devices, network devices, UE devices, and/or Base Station (BS) devices) may perform radio transmissions including SL communication procedures on portions of the unlicensed spectrum. The SL communication procedures may be configured to include one or more resource allocation procedures supported by radio interface operations between UE and BS (Uu). The Uu interface or link refers to the air interface between the UE and the Radio Access Network (RAN), while the sidelink interface refers to the interface between UEs. SL communications may include unicast communication from a UE device to a BS device or another UE device, as well as unicast or multicast communication from the BS device or the other UE device to the UE device. The first communication mode may include receiving a resource allocation configuration indicating a resource allocation pattern from a core network over the Uu link. The second communication mode may include receiving the resource allocation configuration from the other UE device in one or more resource pools over sidelink. The first communication mode and the second communication mode may be further defined in the same manner as resource allocation mode 1 and resource allocation mode 2 are respectively described in TS 38.300 of the 3GPP standard.

In some embodiments, the unlicensed spectrum are individual unlicensed bands in a bandwidth with a range between 4.1 gigahertz (GHz) and 7.125 GHz. For example, the unlicensed bands may be in the ranges between 5.150 GHz and 5.925 GHz and between 5.925 GHz and 7.125 GHz, which respectively correspond to NR bands n46 and n96/n102 of the Frequency Range (FR1) defined in TS 38.101 of the 3GPP standard.

In one or more embodiments, individual bandwidth parts (BWPs) may be configured to perform the SL transmissions. In some embodiments, an SL BWP is a contiguous set of physical resource blocks (PRBs) in an SL transmission, selected from a contiguous subset of common resource blocks (RBs) for a given numerology (μ) on a given carrier configured for an SL communication procedure. Each SL BWP may be defined for the given numerology (μ) in relation to a subcarrier spacing, a symbol duration, and/or a cyclic prefix (CP) length. A UE device may be configured with four SL BWP for downlink and uplink. One of the SL BWPs may be active for downlink or uplink at any point in time. The SL BWP may be preconfigured (e.g., configured from factory settings) or dynamically configured (e.g., configured from the core network via a BS device or a UE device) to include multiple SL resource pools. At least one SL resource pool may be (pre-)configured in accordance with an integer number of RB sets. The SL resource pool may be a predefined resource pool configured to include a sub-set of PRBs of one RB set. Further, the SL resource pool may be configured in relation to a sub-channel size and a number of sub-channels in the SL resource pool if the SL resource pool includes at least two adjacent RB sets.

In one or more embodiments, the SL communication procedure includes selecting resources for SL transmissions in SL physical channels. Some SL physical channels include Physical Sidelink Broadcast Channel (“PSBCH”), Physical Sidelink Control Channel (“PSCCH”), Physical Sidelink Shared Channel (“PSSCH”), and Physical Sidelink Feedback Channel (“PSFCH”). The PSCCH and PSFCH are standalone channels. The PSCCH includes a part of the Sidelink Channel Information (“SCI”), while the PSSCH may include the rest. The PSFCH may include Sidelink Feedback Control Information (“SFCI”) and HARQ feedback for PSSCH reception. These physical channels may include SL-specific physical signals such as DM-RS, CSI-RS, PT-RS, Sidelink Primary Synchronization Signal (“S-PSS”), and Sidelink Secondary Synchronization Signal (“S-SSS”). The PSCCH may be associated with the DM-RS. Further, the PSSCH may be associated with the DM-RS and the PT-RS. The SL communication procedure may include selecting SL physical channel resources in one or more specific time windows in which one of the aforementioned physical channels is transmitted.

One of the aforementioned time windows may be related to a Channel Occupancy Time (“COT”). The structure of the COT includes multiple slots that may include downlink resources, uplink resources, or flexible resources. The COT structure reduces power consumption and channel access delay. In some embodiments, the COT may be shared for transmission between multiple terminal (e.g., UE devices and/or BS devices with their corresponding UE devices). The locations of PSFCH resources in the COT may be configured, preconfigured (e.g., (pre-)configured), or dynamically indicated to a terminal performing an SL transmission in the COT. The terminal may be configured to obtain COT configuration for an SL transmission. The terminal may determine, based on the COT configuration, a resource selection pattern including resources selected to a bandwidth that includes a portion of an unlicensed spectrum. The terminal may transmit the SL transmission to a terminal (e.g., another UE device or a BS device). The SL transmission may include resources selected in accordance with the resource selection pattern. The resource selection pattern may indicate an additional transmission time window for a PSFCH occasion such that PSFCH resources are selected for a transmission at a time window following the COT. The terminal may be further configured to obtain configuration parameters indicating resources selected for the bandwidth that includes the portion of an unlicensed spectrum, and to perform a resource selection procedure in accordance with the configuration parameters. In this case, the terminal may transmit the SL transmission, in accordance with the resource selection procedure.

In some embodiments, the SL transmission is a PSFCH cross-COT transmission including a PSFCH transmission in a COT shared with the PSSCH. This PSFCH cross-COT transmission may include the PSFCH occasion within the shared PSSCH COT. The PSFCH occasion may be included within or outside the shared PSSCH COT. In other embodiments, the PSFCH cross-COT transmission may include the PSFCH occasion in a short control signal transmission following the shared PSSCH COT. Alternatively, the PSFCH cross-COT transmission includes the PSFCH occasion in a time window following the shared PSSCH COT. In one case, a position of the PSFCH occasion in the time window may be associated with a Type 1 LBT occasion per PSFCH. In another case, the PSFCH cross-COT transmission may include the PSFCH occasion in a time window following the shared PSSCH COT, where a position of the PSFCH occasion in the time window is associated with a new COT.

In some embodiments, the COT configuration is defined by configuration parameters received via higher layer signaling or by preconfiguration parameters retrieved from a memory. The SL transmission may be a PSFCH transmission within a shared PSSCH COT. The PSFCH transmission may include a PSFCH dummy occasion and the PSFCH occasion within the shared PSSCH COT. The PSFCH dummy transmission may be a PSFCH transmission sent to reserve resources in the shared PSSCH COT. The PSFCH dummy transmission may be reserved by the terminal or by another terminal exchanging SL transmissions. The PSFCH dummy transmission may use PSFCH frequency resources and PSCCH/PSSCH resources on a same interlace. The PSFCH dummy transmission uses a common PSFCH frequency resource configured (or (pre-)configured) for a predetermined resource pool.

In some embodiments, PSFCH transmissions dropping due to an LBT failure may be retransmitted. In this regard, the SL transmission includes a retransmission occasion of a PSFCH. The resource selection procedure may indicate configuration information (or (pre-)configuration) information for scheduling of the retransmission. The retransmission may include a time gap defined by an SL resource pool configuration or preconfiguration. The time gap may be located between an initial transmission occasion of the PSFCH and the retransmission of the PSFCH. In some embodiments, a same interlace is used for the initial transmission occasion of the PSFCH and the retransmission of the PSFCH.

In some embodiments, the SL transmission includes a transmission of the PSFCH. In the SL transmission, a same Channel Access Priority Class (“CAPC”) index may be used for the transmission of the PSFCH and a transmission of a PSSCH. In other embodiments, the CAPC index may map the transmission of the PSFCH. The CAPC index may be configured or preconfigured through on the configuration parameters. The CAPC index may be indicated in the PSCCH.

In some embodiments, the terminal is configured to obtain configuration parameters indicating a status of an SL transmission. In the configuration parameters, resources may be selected from the portion of the unlicensed spectrum. The terminal may be configured to transmit a report indicating the status to a core network via a BS device (or another terminal acting relaying information to the BS device). The report may be transmitted in an SL Hybrid Automatic Repeat ReQuest (“HARQ”)-acknowledgement (“ACK”) reporting signal to the BS device. The SL HARQ-ACK report may be configured in accordance with a type 1 HARQ-ACK codebook or a type 2 HARQ-ACK codebook. In the SL HARQ-ACK report, a negative acknowledgment or not acknowledged (“NACK”) bit may be used in a case the terminal does not perform a PSCCH/PSSCH transmission or a PSFCH reception due to a listen-before-talk (“LBT”) failure.

The UE device may be configured to perform one or more SL transmissions as part of the SL communication procedure. The one or more SL transmissions may be transmissions (or reception of transmissions) following protocols in which the UE device selects resources in accordance with the indexed frequency resources.

The UE device may implement the SL communication procedure upon receiving instructions from one of its neighboring terminals or upon receiving approval from one of its neighboring terminals after requesting an initialization of the SL communication procedure. The UE device may coordinate the SL transmissions with terminals connected through multiple radio access technologies (RATs) (i.e., LTE-A, 5G NR, and the upcoming 6G).

In some embodiments, the UE device is configured to perform the SL transmissions without negatively impacting a user's experience. To achieve this, the UE device allocates resources in the unlicensed spectrum without taking data integrity away from communication resources selected in the licensed spectrum of a same SL transmission. Successful selection of frequency resources in the unlicensed spectrum and the licensed spectrum in the same SL transmission may prevent data rate reductions, delay increases, or jitter. In this regard, the UE device obtains communication parameters that define reference information indicating resource selection for the SL communication procedure. The UE device may use the communication parameters to determine a resource selection pattern to be used in the SL transmission procedure.

The resource selection pattern may be determined based on parameters obtained for the SL transmission procedure. In one or more embodiments, the UE device identifies an SL resources pool including a set of SL resources for communicating directly with one or more additional terminals in the SL transmission procedure. The resource selection pattern may be determined based on the SL resources pool identified and/or may include resources selected to at least a portion of the set of SL resources in the SL resources pool. The SL resources pool may be an existing SL resources pool previously configured for the SL communication procedure and/or may be an independent SL resources pool selected specifically for the SL communication procedure.

The UE device may initiate the SL communication procedure by transmitting, to the neighboring terminal, a broadcasting signal, which may include terminal capability and at least one communication request. The terminal capability may be communication information regarding one or more transmission and reception capabilities of the UE device, while the communication request may include a request for a start of the communication procedure to the neighboring terminal.

As described above, the parameters may be received by the UE device from the neighboring terminal via an SL communication link. If the neighboring terminal is another UE device, the parameters may be obtained from the other UE device via additional communication links established with a core network. If the neighboring terminal is a base station, the parameters may be obtained from the base station via higher layer signaling (e.g., signaling received from upper layers using Radio Resource Control (RRC) messaging or medium Access Control (MAC) messaging in devices connected to the core network).

The following is a glossary of terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to”may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S. C. § 112(f) interpretation for that component.

### Example Wireless Communication System

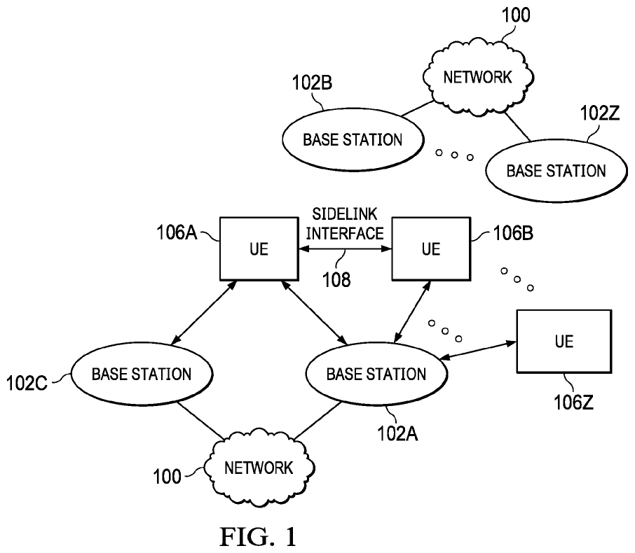

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherpr23 enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1,2,4, or 8).

### Description of Sidelink (SL) Communication Links

In one or more embodiments, SL communication links are communication links established between terminals acting as UE devices. In SL communication links, each aforementioned physical channels corresponds to a set of resource elements carrying information originating from higher layers. These physical signals may include reference information signaling and synchronization information signaling. The reference information signaling may include reference information identifying at least one terminal a positioning reference using a reference signal (e.g., a demodulation reference signal). The positioning reference may be a terminal that is configured to obtain its absolute location on Earth or location within a specific area. The synchronization information signaling may include synchronization information relating to selection of resources for at least one synchronization signal.

In one or more embodiments, two UE devices communicating with one another may exchange SL transmissions using the SL communication link. The SL communication link may be defined for 5G NR in TS 38.331 of the 3GPP standard.

The reference signal is used to provide multiple terminals with a baseline transmission information that these terminals may identifying on SL transmissions exchanged with one other. As described above, reference signals are predefined signals occupying specific resource elements within a communication time-frequency grid. In the NR specification, multiple types of reference signals may be transmitted in different ways and intended to be used for different purposes by a receiving device. In this disclosure, the reference signals are modified for implementation in SL transmissions.

Examples of synchronization information may include communication information relating to selection of resources for at least one synchronization signal. A first option for the synchronization signal may be a Demodulation Reference Signal (DMRS) used for the PSCCH. In an Orthogonal Frequency Division Multiplexing (OFDM) symbol for the PSSCH, the synchronization signal may be the associated DMRS. A second option for the synchronization signal may be a DMRS for Demodulation Reference Signal (DMRS) used for the PSSCH. A third option for the synchronization signal may be a Phase Tracking Reference Signal (PTRS) configured to track phase changes and compensate phase noise during SL transmissions, which may be used for higher carrier frequencies. A time density and a frequency of the PTRS may be configured by the upper layers and may be configured per resource pool. A fourth option for the synchronization signal may be a Channel-State Information Reference Signal (CSI-RS). The CSI-RS may be used for channel sounding. The receiving device may measure the received CSI-RS, then may report back the CSI to the transmitter via the PSSCH. The CSI-RS may be configurable in both the time domain and frequency domain. The CSI-RS may be used to provide fine channel state information. A fifth option for the synchronization signal may be a Synchronization Signal (SS)/PSBCH Block. A slot that transmits the SS/PSBCH block may be referred to as a Sidelink Synchronization Signal Block (S-SSB). The SS/PSBCH block may include PSBCH, Sidelink Primary Synchronization Signal (SPSS) and Sidelink Secondary Synchronization Signal (SSSS) symbols. The period of the S-SSB transmission may be 16 frames, and within each period, the number of S-SSB blocks N in the S-SSB period is configured at the RRC. The range of choices for N may vary based on the numerology and the frequency range.

In one or more embodiments, the UE devices are configured to handle simultaneous sidelink and uplink/downlink transmissions. If any of the UE devices include limited reception capabilities in comparison to the rest of the UE devices, this UE device may prioritize sidelink communication reception, sidelink discovery reception on carriers configured by the eNodeB, and last sidelink discovery reception on carriers not configured by the gNB.

Sidelink transmissions may be organized into radio frames with a duration of T_{f}, each consisting of 20 slots of duration Tₛₗₒₜ. A sidelink subframe consists of two consecutive slots, starting with an even-numbered slot. A transmitted physical channel or signaling in a slot may be described by a resource grid corresponding to a first number of subcarriers and a second number of Single-Carrier (SC)-Frequency Division Multiple Access (FDMA) symbols.

In some embodiments, SL transmissions may be configured in accordance with a resource allocation pattern provided by the gNB. The resource allocation pattern may provide dynamic grants of resources, as well as grants of periodic sidelink resources configured semi-statically by sidelink configured grants. To improve a reliability of the SL transmissions, a dynamic sidelink grant DCI may provide resources for one or multiple transmissions of a transport block. The sidelink configured grants may be SL transmissions configured to be used by the UE device immediately, until these grants are released by RRC signaling. The UE device may be allowed to continue using this type of sidelink configured grants when beam failure or physical layer problems occur in NR access links (Uu) until a Radio Link Failure (RLF) detection timer expires, before falling back to an exception resource pool. Another type of sidelink configured grant may be a grant that is configured once and may not be used until the gNB sends the UE device a DCI indicating that the grant is now active, and until another DCI indicates deactivation.

In the sidelink configured grants, the resources are a set of sidelink resources recurring with a periodicity which the gNB matches resourced to those characterize for V2X traffic. Multiple configured grants can be configured, to allow provision for different services, traffic types, and the like. Modulation and Coding Scheme (MCS) information for dynamic and configured grants may be optionally provided or constrained by the RRC signaling instead of the DCI. The RRC may configure exact MCS the uses, or a range of MCSs. The MCS may also be left unconfigured. For the cases where the RRC does not provide the exact MCS, the UE device may be left to select an appropriate MCS itself based on any knowledge it may have of the transport block to be transmitted and sidelink radio conditions. The gNB scheduling activity may be driven by reporting in which the UE device shares its sidelink traffic characteristics to the gNB, or by performing a sidelink Buffer Status Report (BSR) procedure similar to that of the Uu to request the sidelink resource allocation from the gNB.

In some embodiments, the SL transmissions for the UE device may be configured in accordance with a self-selected resource allocation pattern (i.e., hereinafter referred to as resource selection pattern). The SL transmissions may be transmitted by the UE device a certain number of times after a resource selection pattern is selected, or until a cause of resource reselection is triggered. The SL transmissions may be performed to support unicast and groupcast communications in the physical layer. The SL transmissions may be configured to reserve resources to be used for a number of blind transmissions or HARQ-feedback-based transmissions of the transport block. The SL transmissions may be performed to select resources to be used for the initial transmission of a later transport block.

In one or more embodiments, the resource selection patterns selected for the SL transmissions may be implemented in SL Bandwidth Parts (BWP). SL BWP may be sets of contiguous resource blocks configured for the SL transmissions inside a predetermined channel bandwidth. The configuration of the SL BWP and SL resource pools is established by the RRC layer and provided to lower layers when activated. There may be at least one active SL BWP for the UE device at a time in a given frequency band. The SL BWP may be defined by its frequency, bandwidth, Subcarrier Spacing (SCS), and Cyclic Prefix (CP). The SL BWP may define parameters common to all the SL resource pools that are contained within it, namely a number of symbols and starting symbol used for SL in all slots (except those with Synchronization Signal Block (SSB)), power control for PSBCH, and a location of a Direct Current (DC) subcarrier.

The SL BWP may have different lists of SL resource pools for transmissions and receptions, to allow for the UE device to transmit in a pool and receive in another one. For transmissions, there may be one pool for a selected mode, one for a scheduled mode (e.g., when the gNodeB helps with resource selection), and one for exceptional situations. These SL resource pools may be expected to be used for only transmission or reception, except when SL feedback mechanisms are activated, in which case the UE device may transmit Acknowledgement (ACK) messages in a reception pool and receive ACK messages in a transmission pool.

In 5G NR technologies, the SL resource pool may be located inside an SL BWP is defined by a set of contiguous Resource Blocks (RBs) defined by the information element labeled sl-Rb-Number in the frequency domain starting at an RB defined by the information element labeled sl-StartRBsubchannel. Further, the SL resource pool may be divided into sub-channels of a size defined by the information element labeled sl-SubchannelSize, which can take one of multiple values (i.e., 10, 12, 15, 20, 25, 50, 75, and 100). Depending on the value of sl-RB-Number and sl-SubchannelSize, some RBs inside the SL resource pool may not be used by the UEs.

In the time domain, an SL resource pool has some available slots configured by various parameters. To determine which slots belong to the pool, a series of criteria may be applied. The slots where SSB is transmitted may not be used. The number and locations of those slots may be based on a predefined configuration. Slots that are not selected for UL (e.g., in the case of Time Division Multiplexing (TDD)) or do not have all the symbols available (as per SL BWP configuration) may also be excluded from the SL resource pool. Some slots may be reserved such that a number of remaining slots is a multiple of a bitmap length defined by the labels sl-TimeResource-r16 or Lbitmap, that can range from 10 bits to 160 bits. The reserved slots may be spread throughout a variable number of slots. The bitmap sl-TimeResource-r16 may be applied to the remaining slots to compute a final set of identified/labeled slots that belong to the pool.

In some embodiments, the duration of each SL frame and SL subframe is 10 milliseconds (ms) and 1 ms, respectively. The SL frames and SL subframes may include a numerology μ which may define the SCS, a number of slots in a subframe, and cyclic prefix options. In NR SL, the value of μ ranges from 0 to 3. In addition, the supported u values vary at different frequency bands. In the frequency domain, the SCS may be defined by the numerology. In this regard, the SCS may be directly proportional to the numerology. Within the SL subframe, slots may be numbered from 0 to N subframe. In NR, given that different UE devices may operate in a different BWP and using a different numerology, a common resource block may be used for a device to locate frequency resources within the carrier bandwidth.

In some embodiments, the UE device may map resources in SL communication procedures with one or more BS devices and/or other UE devices. In one example, the UE device may obtain parameters indicating resources selected for use in a failed SL transmission. The UE device may determine a resource selection procedure based on the parameters. In this case, the UE device may perform the resource selection procedure for use in a retransmission of the failed SL transmission.

In another example, the UE device may obtain parameters indicating a status of an SL transmission in a portion of an unlicensed spectrum. In this case, the UE device may transmit a sidelink (SL) Hybrid Automatic Repeat ReQuest (HARQ) report indicating the status to a core network.

### Example Communication Device

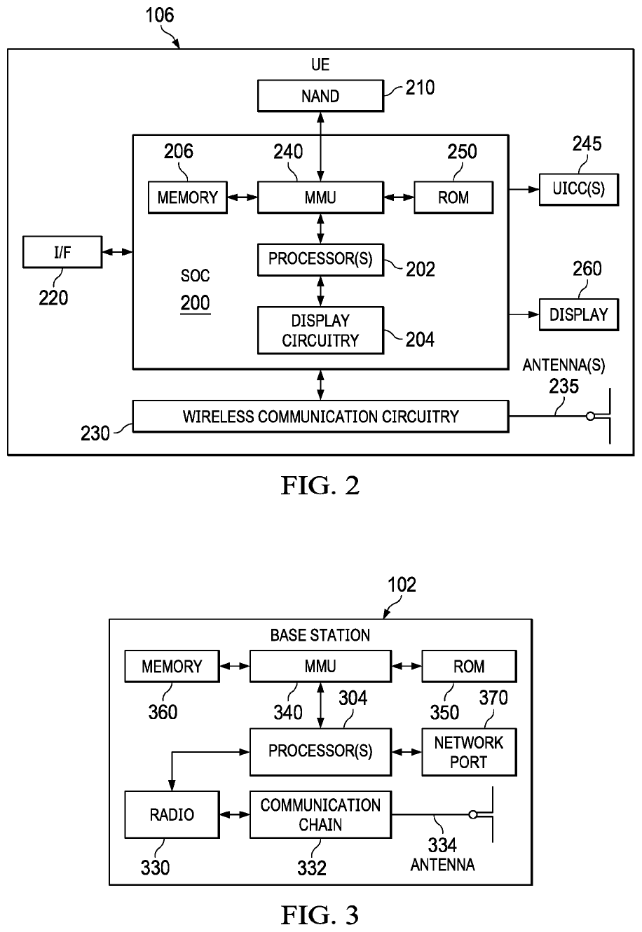

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mm Wave frequency range are heavily attenuated by environmental factors. To help address this attenuating, mm Wave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 245 that include Subscriber Identity Module (SIM) functionality, such as one or more Universal Integrated Circuit Card(s) (UICC(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

FIG. 3 illustrates an example block diagram of a base station 102, according to some aspects. It is noted that the base station of FIG. 3 is a non-limiting example of a possible base station. As shown, the base station 102 may include processor(s) 304 which may execute program instructions for the base station 102. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 304 of the base station 102 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 102, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

### Example Cellular Communication Circuitry

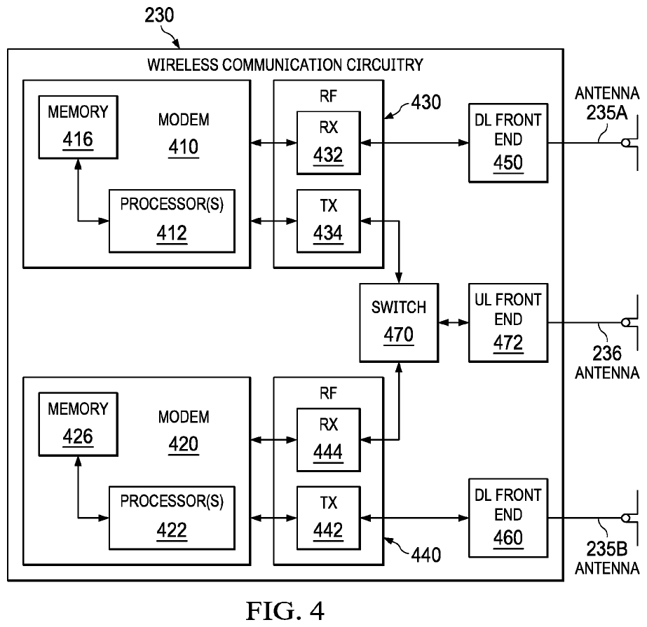

FIG. 4 illustrates an example simplified block diagram of cellular communication circuitry, according to some aspects. It is noted that the block diagram of the cellular communication circuitry of FIG. 4 is only one example of a possible cellular communication circuit; other circuits, such as circuits including or coupled to sufficient antennas for different RATs to perform uplink activities using separate antennas, or circuits including or coupled to fewer antennas (e.g., that may be shared among multiple RATs) are also possible. According to some aspects, cellular communication circuitry 230 may be included in a communication device, such as communication device 106 described above. As noted above, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 230 may couple (e.g., communicatively; directly or indirectly) to one or more antennas, such as antennas 235a, 235b, and 236 as shown. In some aspects, cellular communication circuitry 230 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 4, cellular communication circuitry 230 may include a first modem 410 and a second modem 420. The first modem 410 may be configured for communications according to a first RAT, e.g., such as LTE or LTE-A, and the second modem 420 may be configured for communications according to a second RAT, e.g., such as 5G NR.

As shown, the first modem 410 may include one or more processors 412 and a memory 416 in communication with processors 412. Modem 410 may be in communication with a radio frequency (RF) front end 430. RF front end 430 may include circuitry for transmitting and receiving radio signals. For example, RF front end 430 may include receive circuitry (RX) 432 and transmit circuitry (TX) 434. In some aspects, receive circuitry 432 may be in communication with downlink (DL) front end 450, which may include circuitry for receiving radio signals via antenna 235a.

Similarly, the second modem 420 may include one or more processors 422 and a memory 426 in communication with processors 422. Modem 420 may be in communication with an RF front end 440. RF front end 440 may include circuitry for transmitting and receiving radio signals. For example, RF front end 440 may include receive circuitry 442 and transmit circuitry 444. In some aspects, receive circuitry 442 may be in communication with DL front end 460, which may include circuitry for receiving radio signals via antenna 235b.

In some aspects, a switch 470 may couple transmit circuitry 434 to uplink (UL) front end 472. In addition, switch 470 may couple transmit circuitry 444 to UL front end 472. UL front end 472 may include circuitry for transmitting radio signals via antenna 236. Thus, when cellular communication circuitry 230 receives instructions to transmit according to the first RAT (e.g., as supported via the first modem 410), switch 470 may be switched to a first state that allows the first modem 410 to transmit signals according to the first RAT (e.g., via a transmit chain that includes transmit circuitry 434 and UL front end 472). Similarly, when cellular communication circuitry 230 receives instructions to transmit according to the second RAT (e.g., as supported via the second modem 420), switch 470 may be switched to a second state that allows the second modem 420 to transmit signals according to the second RAT (e.g., via a transmit chain that includes transmit circuitry 444 and UL front end 472).

As described herein, the first modem 410 and/or the second modem 420 may include hardware and software components for implementing any of the various features and techniques described herein. The processors 412, 422 may be configured to implement part or all of the features described herein, e.g., by executing program instructions stored on a memory medium (e.g., a non-transitory computer-readable memory medium). Alternatively (or in addition), processors 412, 422 may be configured as a programmable hardware element, such as an FPGA (Field Programmable Gate Array), or as an ASIC (Application Specific Integrated Circuit). Alternatively (or in addition) the processors 412, 422, in conjunction with one or more of the other components 430, 432, 434, 440, 442, 444, 450, 470, 472, 235 and 236 may be configured to implement part or all of the features described herein.

In addition, as described herein, processors 412, 422 may include one or more processing elements. Thus, processors 412, 422 may include one or more integrated circuits (ICs) that are configured to perform the functions of processors 412, 422. In addition, each integrated circuit may include circuitry (e.g., first circuitry, second circuitry, and the like) configured to perform the functions of processors 412, 422.

In some aspects, the cellular communication circuitry 230 may include only one transmit/receive chain. For example, the cellular communication circuitry 230 may not include the modem 420, the RF front end 440, the DL front end 460, and/or the antenna 235b. As another example, the cellular communication circuitry 230 may not include the modem 410, the RF front end 430, the DL front end 450, and/or the antenna 235a. In some aspects, the cellular communication circuitry 230 may also not include the switch 470, and the RF front end 430 or the RF front end 440 may be in communication, e.g., directly, with the UL front end 472.

### Example SL Communication Link Management

SL communication links may be used to help reduce interference and to help support a large number of wireless devices that are neighboring one another. The SL communication links effectively allows transmission and reception of SL transmissions. In some embodiments, the beams are representations of communication being shared between two wireless devices. These SL transmissions may be directed by each wireless device. In some embodiments, the SL transmissions with a predetermined direction may be referred to as beams. As the beams are directed toward a relatively small area as compared to a cell wide signal, a wireless node needs to know where a wireless device is located relative to the wireless node to allow the wireless node to direct beams toward the wireless device.

### Example of a Slot Structure

A slot structure of a radio frame in an SL transmission may include multiple different types of resources. In some embodiments, the resources are selected in a predetermined pattern including 10 PRBs/sub-channels. This predetermined pattern may be a configuration for implementing SL transmissions in 5G NR. The predetermined pattern may include resources selected for a PSCCH, a PSSCH, an automatic gain control (AGC) symbol, a GAP symbol, and a PSFCH symbol including AGC training. In the slot, the AGC symbol may be a copy of a next symbol. The AGC symbol may be used in the slot to automatically control an increase in an amplitude of the radio frame.

In the slot, the AGC symbol may be a first symbol in a slot for AGC training and a first sidelink symbol may be a copy of a second sidelink symbol. The PSCCH may be a channel configured for sidelink control information. The PSCCH may include SL control information (SCI) stage 1 with information related to resource allocation in a first stage SCI A type as defined in TS 38.214 of the 3GPP standard. The PSCCH may start from the second symbol in the slot and may last 2 or 3 symbols in the time domain. The PSCCH may be pre-configured or dynamically assigned. The PSCCH may occupy several contiguous PRBs in the frequency domain. The PSCCH may be configured with candidate numbers including 10, 12, 15, 20, or 25 PRBs. The lowest PRB of the PSCCH is the same as the lowest PRB of the corresponding PSSCH. The PSSCH may be configured for sidelink data. The PSSCH may be configured to include a second stage SCI information about data transmission and feedback in SCI 2-A (e.g., unicast, groupcast, broadcast) and SCI 2-B (e.g., Groupcast) as defined in TS 38.214 of the 3GPP standard. The GAP symbol may be a symbol used for GAP (i.e., Tx/Rx switch) right after a PSSCH transmission. The PSFCH symbol may be configured for sidelink HARQ feedback. The slot may include a PSBCH that may be configured for sidelink broadcast information and an S-SSB for synchronization.

In some embodiments, the slot is included in an SL BWP. The slot may be part of an SL resource pool including a set of time-frequency resources for SL transmission and/or reception. The slot may be used in SL transmissions involving unicast, groupcast, and broadcast for a given UE device.

In 5G NR, the PSCCH and the PSBCH may include a DMRS reused for resource mapping and sequencing. Sidelink CSI-RS may be refined in the PSSCH. The sidelink CSI-RS configuration may be given by a PC5 interface, from the UE device transmitting the sidelink CSI-RS. Sidelink PTRS may be refined in the PSSCH. Further, in 5G NR, a UE device may be configured with one or more reference signal information elements, such as those described in TS 38.211, TS 38.214, and TS 38.331 of the 3GPP standard.

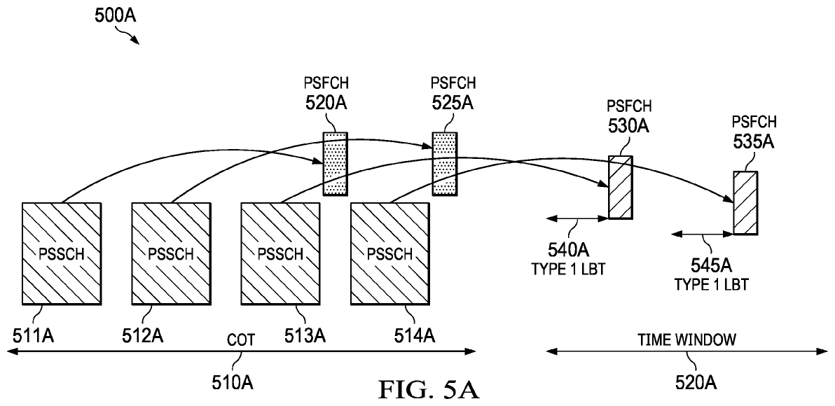

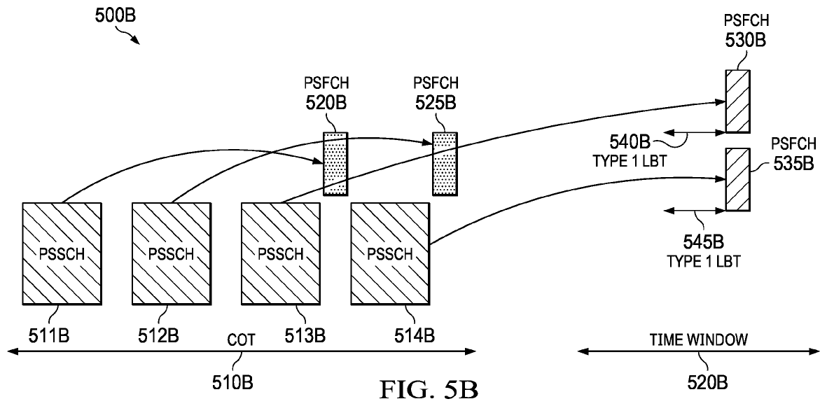

In one or more embodiments, a terminal may receive configuration parameters from a core network (e.g., a gNB) or may receive (pre-)configured parameters. The parameters may be definitions for one or more communication procedures. The parameters may include configuration information to implement an SL communication procedure in which resources are selected for a bandwidth that includes a portion of an unlicensed spectrum. The terminal may be configured to determine, based on the parameters, a resource selection pattern for the SL communication procedure. The terminal may identify an SL resource pool in the parameters. The parameters may be information for selecting resources to one or more PRBs or information for indexing resources to one or more PRBs for a predetermined channel/sub-channel. The parameters may be information for selecting time resources for multiple SL transmissions in a SL communication procedure. The SL transmissions may be one of those described in detail in reference to FIGS. 5A-12.

FIGS. 5A and 5B are diagrams illustrating examples of SL transmissions over various time windows. In these figures, PSFCH cross-COT transmissions are (pre-)configured to reuse time gaps between PSSCH occasions and PSFCH occasions. In some embodiments, if a PSFCH occasion is within the COT of a PSSCH, then a single PSFCH occasion may be applied. In this regard, the time domain resource mapping between the PSSCH occasion and the PSFCH occasion may follow R16/17 NR Sidelink guidelines described in the 3GPP standard. Under this resource mapping, no additional signaling may be needed. If a PSFCH occasion is outside a COT including PSSCH transmissions, then a time window may be used for the PSFCH transmission. In FIGS. 5A and 5B, the PSFCH occasions are received within time window outside the COT. The time window may be (pre-)configured per SL resource pool or dynamically indicated in SCI (i.e., stage 2 to map service requirements into network capabilities) signaling as defined by a packet delay budget or information elements related to DCI 3_0 in mode 1 applications.

In some embodiments, a time window starts 2 or 3 slots after the PSSCH occasions. In this case, only the time window duration may be (pre-)configured or indicated (e.g., indicating a time duration by the number of slots). In other embodiments, both the starting time and the time window duration are (pre-)configured or indicated. In this case, a starting time slot may be expressed in the number of slots after the PSSCH transmissions.

As shown in FIGS. 5A and 5B, the PSFCH cross-COT transmission includes PSFCH occasions outside the COT of the PSSCH. In these embodiments, the channels are (pre-)configured in out-of-COT PSFCH transmissions. In some cases, no LBT is used for transmitting the PSFCH occasions. Instead, only a short control signal transmission may be used for the time window. In other cases, Type 1 LBT is used for the time window per PSFCH occasion or per COT.

As shown in FIG. 5A, multiple PSFCH transmissions may be conducted for multiple PSSCH transmissions in the COT. In this case, the PSFCH occasions may occur at multiple PSSCH transmissions. The PSFCH frequency locations may be (pre-)configured per a given SL resource pool, which may be different from any legacy PSFCH frequency locations. In other cases, dedicated PSFCH frequency resources may be used for the out-of-COT PSFCH transmissions. These frequency resources may be (pre-)configured by SL resource pools. For example, a special cyclic shift pairs may be used for the out-of-COT PSFCH transmissions.

In FIG. 5A, an SL transmission 500A includes a COT 510A with a time duration including slots for multiple PSSCH occasions 511A-514A. Each of these PSSCH occasions 511A-514A are separated by time gaps (space between any two subsequent PSSCH occasions). In some embodiments, time gaps are overlapped with PSFCH occasions. This is the case for PSFCH occasions 520A and 525A, which are transmitted two slots after a corresponding PSSCH occasion. For example, the PSFCH occasion 520A is transmitted after the PSSCH occasion 512A and the PSSCH occasion 513A. In FIG. 5A, the PSSCH occasions 511A-514A and the PSFCH occasions 520A and 525A are included in the COT 510A. The COT 510A may be referred to as a shared PSSCH COT given that this is a COT shared with PSSCH occasion transmissions.

Further, FIG. 5A shows a time window 520A in which additional PSFCH occasions 530A and 535A transmitted. The transmissions for the additional PSFCH occasions 530A and 535A are transmitted using respective time intervals using Type 1 LBT 540A and a Type 1 LBT 545A. In this case, the PSFCH occasions 530A and 535A are selected for different times in the time window 520A.

Turning to FIG. 5B, an SL transmission 500B is shown to include a COT 510B with a time duration including slots for multiple PSSCH occasions 511B-514B. Similar to the SL transmission 500A described in reference to FIG. 5A, each of these PSSCH occasions 511B-514B are separated by time gaps (space between any two subsequent PSSCH occasions). In some embodiments, time gaps are overlapped with PSFCH occasions. This is the case for PSFCH occasions 520B and 525B, which are transmitted two slots after a corresponding PSSCH occasion. For example, the PSFCH occasion 525B is transmitted after the PSSCH occasion 513B and the PSSCH occasion 514B. In FIG. 5B, the PSSCH occasions 511B-514B and the PSFCH occasions 520B and 525B are included in the COT 510B. The COT 510B may be referred to as a shared PSSCH COT given that this is a COT shared with PSSCH occasion transmissions.

Further, FIG. 5B shows a time window 520B in which additional PSFCH occasions 530B and 535B transmitted. In this case, the PSFCH occasions may be merged to be transmitted at a same time. The transmissions for the additional PSFCH occasions 530B and 535B are transmitted using a time intervals using Type 1 LBT 540B or a Type 1 LBT 545B. In this case, the PSFCH occasions 530B and 535B are selected at a same time in the time window 520B.

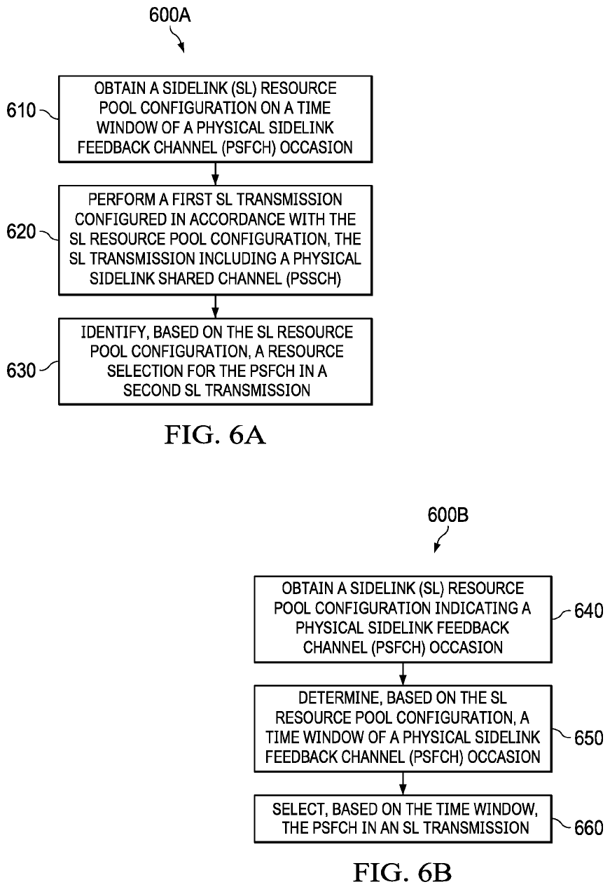

Turning to FIGS. 6A and 6B, flowcharts are shown, detailing methods of selecting time resources in SL transmissions, in accordance with one or more embodiments. In this example, the methods are executed by a terminal exchanging information via SL communication links established with a base station and/or one or more neighboring terminals. In FIG. 6A, the method 600A may be performed by a terminal transmitting or receiving a PSFCH occasion based on an SL resource pool configuration.

At 610, the flowchart begins with the terminal configured to obtain, an SL resource pool configuration on a time window of a PSFCH occasion. Both the terminal transmitting the SL transmission (Tx terminal) and the terminal receiving the SL transmission (Rx terminal) obtain the SL resource pool configuration in the manner described above in reference to FIGS. 1-4.

At 620, the flowchart continues with the terminal configured to perform a first SL transmission configured in accordance with the SL resource pool configuration. The SL transmission may include a PSSCH. For the Tx terminal, the SL transmission refers to transmitting the PSSCH and sharing the COT with the Rx terminal. For the Rx terminal, the SL transmission refers to receiving the PSSCH from the Tx terminal.

The flowchart ends at 630, where the terminal identifies, based on the SL resource pool configuration, a resource selection for the PSFCH occasion in a second SL transmission. For the Tx terminal, if the PSFCH occasion is within a duration of the COT, then the PSFCH occasion is received in the (pre-)configured slot at a specific PSFCH resource. Further, if the PSFCH occasion is outside the duration of the COT, then the PSFCH occasion is received based on a configured time window. For the Rx terminal, if the PSFCH occasion is within the duration of the COT, then the PSFCH occasion is transmitted in the (pre-)configured slot at the specific PSFCH resource. If the PSFCH occasion is outside the duration of the COT, then the PSFCH occasion is transmitted based on the configured time window.

Turning to FIG. 6B, the method 600B may be performed by a terminal transmitting or receiving a PSFCH occasion based on an SCI indication. At 640, the flowchart begins with a terminal configured to obtain an SL resource pool configuration indicating a PSFCH occasion. Both the Tx terminal and the Rx terminal obtain the SL resource pool configuration in the manner described above in reference to FIGS. 1-4. Upon obtaining the SL resource pool, the Tx terminal transmits the PSSCH and shares the COT with the Rx terminal. In turn, the Rx terminal receives the PSSCH from the Tx terminal.

At 650, the flowchart continues with the terminal configured to determine, based on the SL resource pool configuration, the time window for the PSFCH occasion. For the Tx terminal, if the PSFCH occasion is outside the COT duration, then the Tx terminal indicates the time window of the PSFCH occasion in the SCI associated with the PSSCH. For the Rx terminal, if the PSFCH is outside the shared COT duration, then the Rx terminal uses the time window of the PSFCH occasion in the SCI associated with the PSSCH.

The flowchart ends at 660 where the terminal selects, based on the time window, the PSFCH occasion in an SL transmission. For the Tx terminal, the SL transmission refers to receiving the PSFCH occasion based on the indicated time window. For the Rx terminal, the SL transmission refers to transmitting the PSFCH occasion based on the indicated time window.

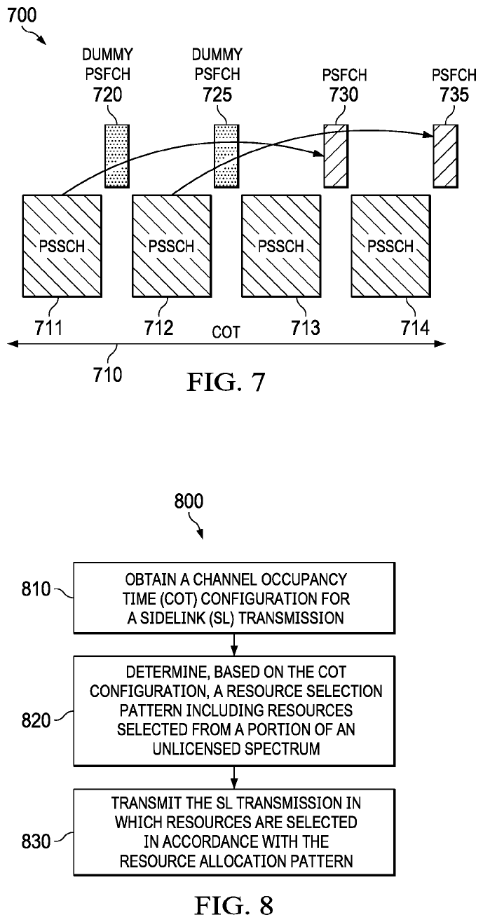

FIG. 7 illustrates an example of an SL transmission 700, in accordance with one or more embodiments. In this example, the SL transmission 700 includes a COT 710 with a time duration including slots for multiple PSSCH occasions 711-714. Each of these PSSCH occasions 711-714 are separated by time gaps (space between any two subsequent PSSCH occasions). In some embodiments, time gaps are overlapped with PSFCH occasions. This is the case for PSFCH occasions 730 and 735, which are transmitted two slots after a corresponding PSSCH occasion. For example, the PSFCH 730 is transmitted after the PSSCH occasion 712 and the PSSCH occasion 713. In the example of FIG. 7, dummy PSFCH occasions 720 and 725 may also be overlapped with time gaps without PSFCH occasions. These dummy PSFCH occasions 720 and 725 may be resources selected to preserve same transmission resources in the COT 710 and do not need to be transmitted two slots after a PSSCH occasion, because the dummy PSFCH occasions 720 and 725 are not associated with any PSSCH occasions. As shown in FIG. 7, the PSSCH occasions 711-714, the dummy PSFCH occasions 720 and 725, and the PSFCH occasions 730 and 735 are included in the COT 710. The COT 710 may be referred to as a shared PSSCH COT given that this is a COT shared with PSSCH occasion transmissions.

As described above, the dummy PSFCH occasions are transmitted to maintain the duration of the COT 710. If a Tx terminal occupies the COT 710 for contiguous data transmissions, then an Rx terminal does not transmit the PSFCH occasion at the beginning of the COT 710. To avoid losing the COT 710, the Tx terminal transmits the dummy PSFCH occasion 720 or 725, which are not expected to be received by the Rx terminal. In some embodiments, the dummy PSFCH occasions 720 and 725 use PSFCH resources on a same interlace as a PSCCH/PSSCH transmission. In other embodiments, the dummy PSFCH occasions 720 and 725 use a common PSFCH resource, which may be (pre-)configured per an SL resource pool.

Turning to FIG. 8, a flowchart is shown, detailing a method 800 of selecting resources in an SL communication procedure, in accordance with one or more embodiments. In this example, the method is executed by a terminal exchanging information via SL communication links established with a base station and/or one or more neighboring terminals. At 810, the flowchart begins with a terminal configured to obtain a COT configuration for an SL transmission. The COT configuration may be one of the (pre-)configuration parameters obtained by the Tx terminal or the Rx terminal described in reference to FIGS. 5-7.

At 820, the flowchart continues with the terminal configured to determine, based on the COT configuration, a resource selection pattern to a bandwidth that includes a portion of an unlicensed spectrum. The resource selection refers to one or more selection instructions defining a timing of a PSFCH occasion or a dummy PSFCH occasion.

The flowchart ends at 830 where the terminal is configured to transmit the SL transmission, in accordance with the resource selection pattern. As described above in reference to FIGS. 5A-7, the SL transmission refers to operations for receiving or transmitting the PSFCH when the method 800 is performed by a Tx terminal or an Rx terminal, respectively.

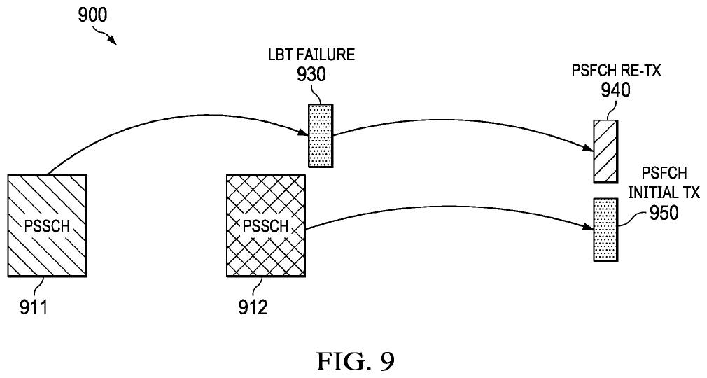

FIG. 9 illustrates an example of an SL communication procedure 900, in accordance with one or more embodiments. In this example, the SL communication procedure 900 includes slots for multiple PSSCH occasions represented by PSSCH occasions 911 and 912. Each of these PSSCH occasions 911 and 912 are separated by time gaps (space between any two subsequent PSSCH occasions). In some embodiments, time gaps are overlapped with PSFCH occasions. In these cases, transmission of the PSFCH occasion may fail, as represented by the LBT failure 930. In FIG. 9, the LBT failure causes a retransmission of the PSFCH occasion.

In FIG. 9, these transmissions are labeled as PSFCH RE-TX 940 and PSFCH Initial TX, which refer to the retransmission of the PSFCH occasion that resulted in the LBT failure 930 and a PSFCH occasion corresponding to another PSSCH occasion (i.e., the PSSCH 912), respectively.

In some embodiments, a resource selection for performing the retransmission of the PSFCH may be (pre-)configured or dynamically defined. As described above, the LBT failure 930 may result from an attempted PSFCH transmission. In this case, additional PSFCH occasions may be (pre-)configured for the PSFCH retransmission. In this regard one or more PSFCH retransmission may be possible. This functionality can be enabled or disabled per SL resource pool (pre-)configuration. In some embodiments, the time gap between the initial PSFCH transmission and the PSFCH retransmission may be (pre-)configured by the SL resource pool. Further, the time gap may be a same time gap (e.g., at least 2 or 3 slots) as the time gap between a PSSCH occasion and a successful PSFCH transmission. The time gap may be the consecutive slots for the initial PSFCH transmission and the PSFCH retransmission. For PSFCH retransmissions, a same interlace as the PSFCH initial transmission may be used. In this case, the SL resource pool may (pre-)configure dedicated cyclic shifts for the PSFCH occasions in code domain. Similarly, the PSFCH retransmission for one PSSCH occasion and a PSFCH initial transmission for another PSSCH occasion may share a same interlace with different cyclic shifts.

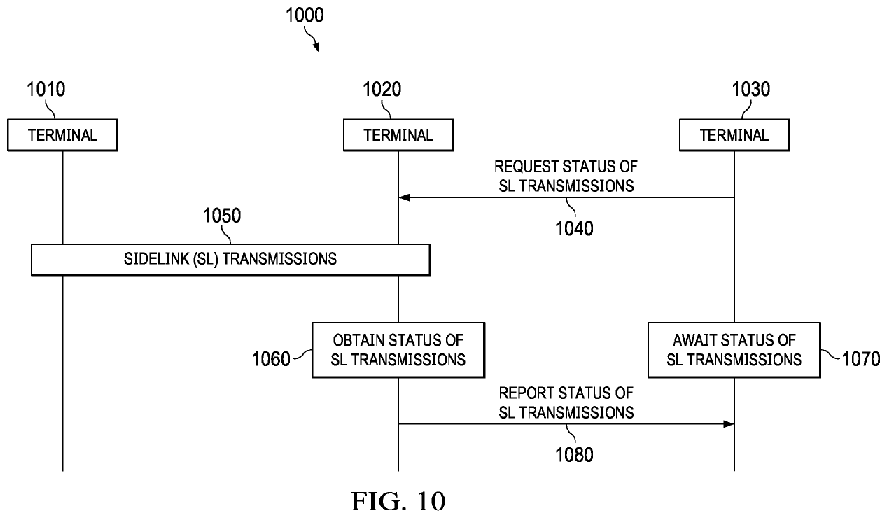

FIG. 10 illustrates an example of an SL communication procedure 1000 in accordance with one or more embodiments. The SL transmission 1000 includes SL transmissions exchanged between two terminals 1010 and 1020. These two terminals may be UE devices configured to exchange and receive multiple SL transmissions as shown by signaling 1050. At least one of the terminals may communicate with another terminal 1030 acting as a base station (i.e., gNB). In signaling 1040, the terminal 1030 may request a status of a specific SL transmissions exchanged by the terminal 1020. Upon receiving this request, in signaling 1060, the terminal 1020 may obtain a status of one or more SL transmissions while the terminal 1030 awaits the requested status of the specific SL transmission (shown in signaling 1070. At this point, the terminal 1020 provides the status of the SL transmission to the terminal 1030 via the signaling 1080.

In some embodiments, the signaling 1080 may be triggered by additional SL transmissions received from the terminal 1010. In the example of FIG. 10, an SL HARQ report may be used to report the status of the specific SL transmission. The status of the SL transmission may indicate whether a PSFCH occasion was transmitted successfully from one terminal to another. The HARQ report may be generated in accordance with a Type 1 HARQ-ACK codebook of a Type 2 HARQ-ACK codebook. In some embodiments, for the HARQ report, the NACK bit is used for the PSCCH/PSSCH resources selected via the terminal 1030 (i.e., via a core network signaling). In this case a Tx terminal does not perform PSCCH/PSSCH transmissions due to an LBT failure. Further, the NACK bit is used for not receiving a PSFCH transmission due to an LBT failure caused by an RX terminal.

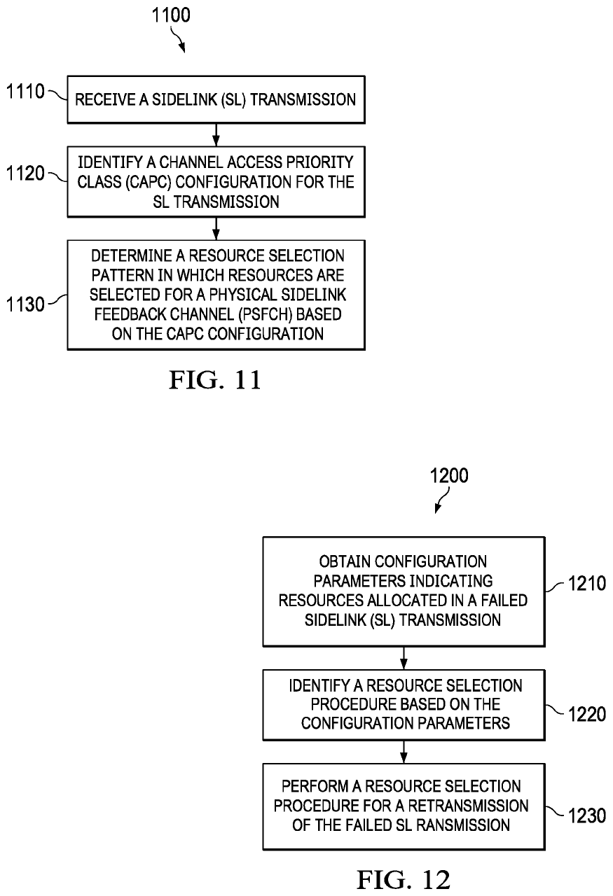

Turning to FIG. 11, a flowchart is shown, detailing a method 1100 of determining a resource selection for an SL communication procedure, in accordance with one or more embodiments. In this example, the method 100 is executed by a terminal exchanging information via SL communication links established with a base station and/or one or more neighboring terminals. The SL communication procedure may include PSFCH transmissions with Type 1 LBT for PSFCH.

At 1110, the flowchart begins with a terminal configured to receive an SL transmission from another terminal. The configuration parameters may include information for enabling the Type 1 LBT for the PSFCH.

At 1120, the flowchart continues where the terminal identifies a CAPC configuration for the SL transmission. In some embodiments, a same CAPC index may be used for PSSCH transmissions. In this case, if the SL communication procedure includes multiple PSFCH transmissions corresponding to multiple PSSCH transmissions, then the smallest index of the CAPC index is used for multiple PSSCH transmission is used for the multiple PSFCH transmission. In other embodiments, a CAPC index for a PSSCH transmission is mapped to a CAPC index for a PSFCH transmission. For example, if the CAPC index is 1 or 2 for the PSSCH transmission, the CAPC index is 1 for the PSFCH transmission. Further, if the CAPC index is 3 or 4 for the PSSCH transmission, then the CAPC index is 2 for the PSFCH transmission. In yet more embodiments, a pre-defined or (pre)configured CAPC value of the PSFCH transmission may be used. In this case, the CAPC index may be selected per resource pool (pre-)configuration. The Type 1 LBT for PSFCH may also be dynamically indicated by SCI for the corresponding PSCCH/PSSCH transmission. In this case, 2 bits may be used to indicate the CAPC index used for the PSFCH transmission.

The flowchart ends at 1130, where the terminal is configured to determine a resource selection pattern, in which resources are selected for the PSFCH based on the CAPC configuration. The resource selection provides selection implementation that enables the Type 1 LBT for the PSFCH.

Turning to FIG. 12, a flowchart is shown, detailing a method 1200 of transmitting an SL transmission, in accordance with one or more embodiments. In this example, the method is executed by a terminal exchanging information via SL communication links established with a base station and/or one or more neighboring terminals.

At 1210, the flowchart begins with a terminal configured to obtain configuration parameters indicating resources selected for a failed SL transmission in a bandwidth that includes a portion of the unlicensed spectrum. As described above, the unlicensed spectrum are individual unlicensed bands in a bandwidth with a range between 4.1 gigahertz (GHz) and 7.125 GHz. The configuration parameters may include a status of Type 1 LBT that indicates a PSFCH transmission status.

At 1220, the flowchart continues where the terminal identifies a resource selection procedure based on the configuration parameters. In this regard, the resource selection procedure may identify resources to be selected to enable the Type 1 LBT for the PSFCH.

The flowchart ends at 1230, where the terminal performs the resource selection identified in 1220. The resource selection procedure may include selecting resources for a retransmission of the SL transmission. The terminal implements the resource selection procedures that enable the Type 1 LBT for the PSFCH.

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A terminal comprising:
a receiver configured to receive one or more sidelink (SL) transmissions;
a processor coupled to the receiver and configured to:
obtain parameters indicating resources selected for use in a failed SL transmission,
determine a resource selection procedure based on the parameters, and
perform the resource selection procedure for use in a retransmission of the failed SL transmission.

2. The terminal of claim 1, wherein:
the failed SL transmission includes a retransmission of a Physical Sidelink Feedback Channel (“PSFCH”).

3. The terminal of claim 2, wherein:
the resource selection procedure may indicate configuration information or preconfiguration information for scheduling of the retransmission.

4. The terminal of claim 2, wherein:
a time gap between an initial transmission of the PSFCH and the retransmission of the PSFCH is defined by an SL resource pool configuration or preconfiguration.

5. The terminal of claim 2, wherein:
a same interlace is used for an initial transmission of the PSFCH and the retransmission of the PSFCH.

6. The terminal of claim 2, wherein:
a same Channel Access Priority Class (“CAPC”) index is used for the retransmission of the PSFCH and a transmission of a Physical Sidelink Shared Chanel (“PSSCH”).

7. The terminal of claim 6, wherein:
a Channel Access Priority Class (“CAPC”) index of a transmission of a Physical Sidelink Shared Chanel (“PSSCH”) informs mapping for the retransmission of the PSFCH.

8. The terminal of claim 6, wherein:
a Channel Access Priority Class (“CAPC”) index of the retransmission of the PSFCH may be configured or preconfigured through on the configuration parameters.

9. The terminal of claim 6, wherein:
a Channel Access Priority Class (“CAPC”) index of the retransmission of the PSFCH is indicated in a Physical Sidelink Control Chanel (“PSCCH”).

10. A terminal comprising:
a processor configured to obtain parameters indicating a status of an SL transmission in a portion of an unlicensed spectrum; and
a transmitter coupled to the processor and configured to transmit a sidelink (SL) Hybrid Automatic Repeat ReQuest (HARQ) report indicating the status to a core network.

11. The terminal of claim 10, wherein:
the SL HARQ report is configured in accordance with a type 1 HARQ-acknowledgement (“ACK”) codebook or a type 2 HARQ-ACK codebook.

12. The terminal of claim 10, wherein:
in the SL HARQ report, a negative acknowledgment or not acknowledged (“NACK”) bit is used in a case the terminal does not perform a Physical Sidelink Control Channel (“PSCCH”)/Physical Sidelink Shared Channel (“PSSCH”) transmission or a Physical Sidelink Feedback Channel (“PSFCH”) reception due to a listen-before-talk (“LBT”) failure.

13. A method comprising:
receiving one or more sidelink (SL) transmissions;
obtaining parameters indicating resources selected for use in a failed SL transmission,
determining a resource selection procedure based on the parameters, and
performing the resource selection procedure for use in a retransmission of the failed SL transmission.

14.-24. (canceled)

25. The method of claim 13, wherein:
the failed SL transmission includes a retransmission of a Physical Sidelink Feedback Channel (“PSFCH”).

26. The method of claim 25, wherein:
the resource selection procedure may indicate configuration information or preconfiguration information for scheduling of the retransmission.

27. The method of claim 25, wherein:
a time gap between an initial transmission of the PSFCH and the retransmission of the PSFCH is defined by an SL resource pool configuration or preconfiguration.

28. The method of claim 25, wherein:
a same interlace is used for an initial transmission of the PSFCH and the retransmission of the PSFCH.

29. The method of claim 25, wherein:
a same Channel Access Priority Class (“CAPC”) index is used for the retransmission of the PSFCH and a transmission of a Physical Sidelink Shared Chanel (“PSSCH”).

30. The method of claim 25, wherein:
a Channel Access Priority Class (“CAPC”) index of a transmission of a Physical Sidelink Shared Chanel (“PSSCH”) informs mapping for the retransmission of the PSFCH.

31. The method of claim 25, wherein:
a Channel Access Priority Class (“CAPC”) index of the retransmission of the PSFCH may be configured or preconfigured through on the configuration parameters.
